(19) United States
(12) Patent Application Publication
(10) Pub. No.: US 2016/0012065 A1
(43) Pub. Date: Jan. 14, 2016

(54) INFORMATION PROCESSING SYSTEM AND DATA PROCESSING METHOD THEREFOR

(71) Applicant: HITACHI, LTD., Chiyoda-ku, Tokyo (JP)

(72) Inventors: Masanori TAKATA, Tokyo (JP); Masakuni AGETSUMA, Tokyo (JP); Shoji KODAMA, Tokyo (JP); Masaaki IWASKI, Tokyo (JP)

(73) Assignee: Hitachi, Ltd., Chiyoda-ku, Tokyo (JP)

(21) Appl. No.: 14/768,346

(22) PCT Filed: Sep. 5, 2013
(86) PCT No.: PCT/JP2013/073898

§ 371 Date: Aug. 17, 2015

(51) Int. Cl. G06F 17/30

(52) U.S. Cl. CPC G06F 17/30079; G06F 17/30569; G06F 17/30876; G06F 17/30091

(57) ABSTRACT

The present invention provides a system for realizing both the operation of archive and sharing of contents capable of maintaining a privacy policy of critical data. In order to realize the system, a disclosure condition to a data reference destination and a data conversion method of the file data are designated, and only the file data matching the disclosure condition is provided to the data reference destination by anonymizing the file data via the data conversion method. When the disclosure condition or the data conversion method is changed, an already disclosed file data is deleted, or replaced with the file data subjected to data conversion after the change.

### TECHNICAL FIELD

The present invention relates to an information processing system and a method for processing data in a system composed of a plurality of NAS (Network Attached Storage) devices and a CAS (Content Addressed Storage) device, wherein the NAS device enables a group of files containing critical data archived in the CAS device to be disclosed to a different NAS based on a disclosure condition and a data conversion method.

### BACKGROUND ART

The amount of digital data, especially file data, is increasing rapidly. A NAS device is for sharing file data among multiple computers via a network, and a CAS device is a storage device for archiving data for a long period of time.

Further, a system for collectively managing in the CAS device data distributed in the NAS devices by arranging the CAS device in a data center and arranging NAS devices in the respective sites (such as the head office and branch offices of a company) is proposed, wherein the devices are connected via a communication network. Further, the data archived in the CAS device from the NAS devices can be referred to by other sites by allowing access from other sites, so as to realize the files to be shared among remote sites via the data center.

Patent literatures 1 and 2 teach the art related to the above technique. Patent literature 1 discloses a method for enabling sharing of contents by the files archived in the CAS device from the NAS devices capable of being shared by a different NAS device by referring to the namespace. Patent literature 2 teaches an art of anonymizing patient information of a site and storing the same in a data warehouse (Data Warehouse:DWH) of the center.

### CITATION LIST

### Patent Literature

[PTL 1] US Patent Publication No. 2012/0259813

[PTL 2] Japanese Patent Application Laid-Open Publication No. 2008-130094

### SUMMARY OF INVENTION

### Technical Problem

The art of patent literatures 1 and 2 applied to a use case of archive operation and contents sharing of medical data containing private information of patients result in the following problems. According to the art taught in Patent Literature 1, all file data within the namespace will not be anonymized via a given data conversion method (such as encryption or sanitizing) and the whole original file data is disclosed, so that privacy and security becomes an issue. According to the art disclosed in patent literature 2, the data stored in the DWH of the center is converted, so that it cannot be used in parallel with the archive operation of the site. Further, it may be necessary to generate anonymized data with a different N for each access device referring to the data. In such case, it is necessary to ensure a storage area of a capacity approximately N times the file data to the DWH of the center.

Therefore, one of the objects of the present invention is to realize both preferable archive operation and contents sharing in an environment where critical data such as patient information is subjected to archive operation, by designating the conditions of data to be disclosed to a data reference destination (different site) and the data conversion method, wherein only the data corresponding to the conditions is further anonymized and provided to the data reference destination.

### SOLUTION TO PROBLEM

In order to solve the above problems, one preferred embodiment of the present invention provides a data conversion management device between the NAS devices and the CAS device. The data conversion management device retains a data disclosure rule designated by a disclosure source NAS device in a data disclosure management table, wherein the data disclosure rule includes a disclosure destination of the file data, the disclosure condition, and the data conversion method thereof. The data conversion management device determines whether the archived file data corresponds to the disclosure condition, and creates a stub in a namespace (storage area) disclosed to the data reference destination. When the data reference destination accesses the stub, the data conversion management device anonymizes the requested file data through data conversion via a given data conversion method, stores the same in the namespace, and transfers the same to the data reference destination. Then, when the data disclosure rule is changed, the file data subjected to data conversion stored in the namespace and the reference destination is deleted, or replaced with the new file data subjected to data conversion via the changed data conversion method.

### ADVANTAGEOUS EFFECTS OF INVENTION

According to the information processing system and the data management method of the present invention, data management is facilitated by archive operation, for example, and privacy and security of critical data when data is disclosed to a different site is ensured. The problems, configurations and effects other than those mentioned above will become apparent in the following description of preferred embodiments.

### BRIEF DESCRIPTION OF DRAWINGS

[FIG. 1]

FIG. 1 is a view illustrating a physical configuration example of an information processing system and an outline of a preferred embodiment thereof.

[FIG. 2]

FIG. 2 is a block diagram illustrating a configuration example of hardware and software of a data conversion management device.

[FIG. 3]

FIG. 3 is a block diagram illustrating a configuration example of hardware and software of a NAS device.

[FIG. 4]

FIG. 4 is a block diagram illustrating a configuration example of hardware and software of a CAS device.

[FIG. 5]

FIG. 5 is a view illustrating a configuration example of a data disclosure management table.

[FIG. 6]

FIG. 6 is a view illustrating a configuration example of a conversion tracking table.

[FIG. 7]

FIG. 7 is a flowchart illustrating a data disclosure registration process.

[FIG. 8]

FIG. 8 is a flowchart illustrating a data disclosure processing.

[FIG. 9]

FIG. 9 is a flowchart illustrating a data reference processing.

[FIG. 10]

FIG. 10 is a flowchart illustrating a data disclosure change processing.

[FIG. 11]

FIG. 11 is a flowchart illustrating a first data conversion update processing.

[FIG. 12]

FIG. 12 is a flowchart illustrating a second data conversion update processing.

[FIG. 13]

FIG. 13 is a flowchart illustrating a third data conversion update processing.

[FIG. 14]

FIG. 14 is a flowchart illustrating a fourth data conversion update processing.

[FIG. 15]

FIG. 15 is a view illustrating a configuration example of a data disclosure rule setting/updating GUI interface.

### DESCRIPTION OF EMBODIMENTS

Now, the preferred embodiments of the present invention will be described with reference to the drawings. In the following description, various information may be referred to as “management tables”, for example, but the various information can also be expressed by data structures other than tables. Further, the “management table” can also be referred to as “management information” to indicate that the information does not depend on the data structure.

The processes are sometimes described using the term “program” as the subject. The program is executed by a processor such as an MP (Micro Processor) or a CPU (Central Processing Unit) for performing determined processes. A processor can also be the subject of the processes since the processes are performed using appropriate storage resources (such as memories) and communication interface devices (such as communication ports). The processor can also use dedicated hardware in addition to the CPU. The computer program can be installed to each computer from a program source. The program source can be provided via a program distribution server or a storage media, for example.

In the present embodiment, a communication network such as a WAN or a LAN (Local Area Network) and the like can be adopted as communication network for a NAS device and a CAS device. A file sharing protocol including an NFS (Network File System), a CIFS (Common Internet File System) or an HTTP (Hypertext Transfer Protocol) can be adopted as the protocol of a communication network according to the present embodiment.

The present embodiment uses a NAS device as the site-side storage subsystem, but this is merely an example. A CAS device, a distribution file system such as an HDFS (Hadoop Distributed File System) or an object based storage can be used as the site-side storage subsystem. Further, a CAS device is used as a storage subsystem of a data center, but this is also merely an example. A NAS device, a distribution file system or an object based storage, for example, can be used in addition to the CAS device.

Each element, such as each controller, can be identified via numbers, but other types of identification information such as names can be used as long as they are identifiable information. The equivalent elements are denoted with the same reference numbers in the drawings and the description of the present invention, but the present invention is not restricted to the present embodiments, and other modified examples in conformity with the idea of the present invention are included in the technical scope of the present invention. The number of each component can be one or more than one unless defined otherwise.

### <Overall Configuration of Information Processing System and Outline of Preferred Embodiments>

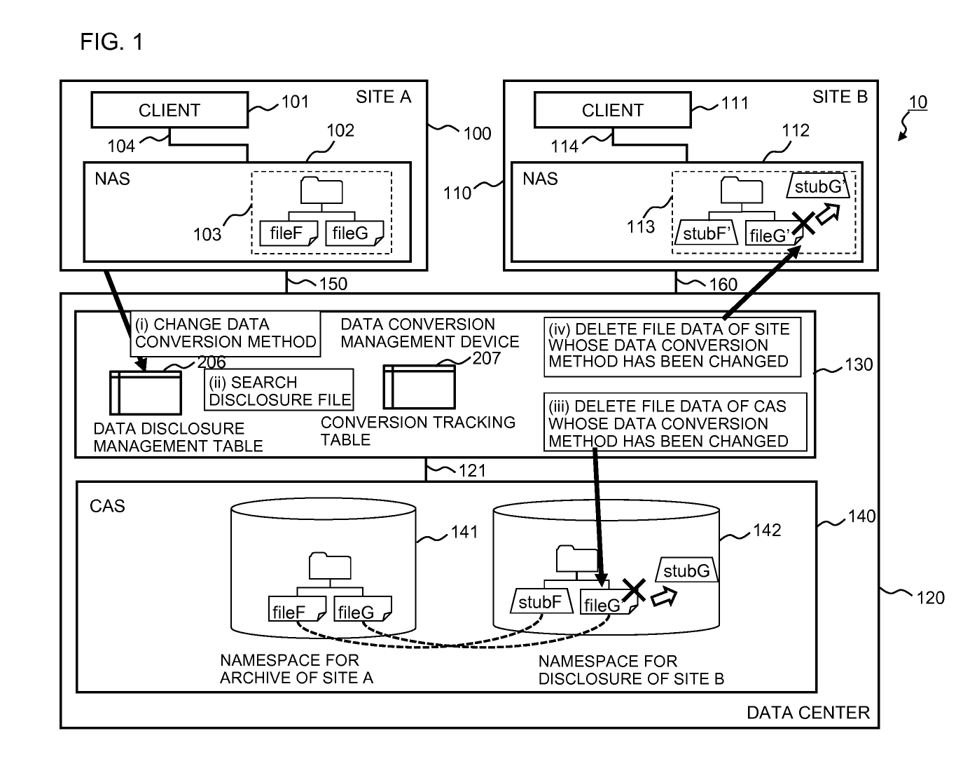

FIG. 1 is a view illustrating a physical configuration example and an outline of a preferred embodiment of an information processing system according to the present embodiment. In FIG. 1, only site A and site B are illustrated, but it is possible to have a larger number of sites included in the information processing system, and the respective sites can be configured similarly.

An information processing system 10 is composed of one or a plurality of sub-computer systems 100 and 110 located at each site, and a data center system 120 composed of a data conversion management device 130 and a CAS device 140, wherein each of the sub-computer systems 100 and 110 and the data center system 120 are connected via networks 150 and 160.

The sub-computer systems 100 and 110 include client computers (hereinafter referred to as clients) 101 and 111, and NAS devices 102 and 112, which are connected via networks 104 and 114. The clients 101 and 111 are one or more computers using a file sharing service provided by the NAS devices 102 and 112. The clients 101 and 111 use the file sharing service provided by the NAS devices 102 and 112 using a file sharing protocol such as NFS and CIFS via networks 104 and 114.

The system administrator accesses a management interface provided by the NAS devices 102 and 112 from the clients 101 and 111, and manages the NAS devices 102 and 112. The management includes, for example, starting of operation of the file server, stopping of the file server, creating of a file system and disclosing the same, and managing of accounts of the clients 101 and 111. Hereafter, the multiple NAS devices 102 can simply be collectively referred to as the NAS device 102. They can also be referred to as NAS A (site A), NAS B (site B) and NAS C (site C) to distinguish the NAS devices for each site.

The NAS devices 102 and 112 include a NAS controller and a storage device. The NAS controller provides a file sharing service to the client, and has a cooperation function with the data conversion management device 130 and the CAS device 140. The NAS controller stores various files created by the client and the file system configuration information in the storage device.

The storage device is a location for providing a volume to the NAS controller, in which the NAS controller stores various files and file system configuration information. The meaning of volume is a logical storage area associated with a physical storage area. Further, a file refers to a unit for managing data, and a file system refers to the management information for managing the file within the volume. Hereafter, the logical storage area within the volume managed by the file system is sometimes simply referred to as file system.

The data center system 120 has a data conversion management device 130 and a CAS device 140, which are connected via a network 121. The CAS device 140 is a storage device as archive and backup destination of the NAS devices 102 and 112. A network 104 is an internal LAN of site A 100, a network 114 is an internal LAN of site B 110, and a network 121 is an internal LAN of the data center system 120, wherein a network 150 connects site A 100 and the data center system 120 via a WAN, and a network 160 connects site B 110 and the data center system 120 via a WAN. The type of the network is not restricted to those described above, and various networks can be used.

Next, we will describe the outline of the present embodiment. A file being archived from NAS 102 of site A to the CAS device 140 is stored in a namespace 141 for archive of site A. The namespace is a management unit having logically divided a tenant (management unit having logically divided a CAS device corresponding to the NAS device) which is a storage area corresponding to a file system of the NAS device.

A memory of the data conversion management device 130 stores a data disclosure management table 206. The data disclosure management table 206 is a table defining a data disclosure rule for disclosing file data from a certain site to a different site, and defines a site name of the file data provision source, a disclosure condition for disclosing file data, and a data conversion method for converting file data. For example, the table stores the disclosure condition for site A 100 to disclose file data to site B 110, and the data conversion method thereof. The data conversion management device 130 creates a namespace 142 for disclosing site B based on the data disclosure rule. When the NAS device 102 of site A 100 archives (migrates) a file data of a file system 103 (file F, file G) to the CAS device 140, the file data is stored in the namespace 141 for archive of site A. Further, a stub (stub F, stub G) of the file data matching the disclosure condition is stored in the namespace 142 for disclosing site B, and is also stored in the NAS device 112 of site B 110 according to the reference request from the client 111 of site B 110. As a result, the client 111 is enabled to access the file data as file system 113 (composed of folders and file data).

The data conversion management device 130 refers to the data disclosure management table 206 to determine whether data conversion is necessary for the file data receiving an access request from site B 110. If data conversion is necessary, the file data of the namespace 141 for archive of site A is converted via a given data conversion method. Then, the file data subjected to data conversion (file G′) is stored in the namespace 142 for disclosing site B, and transmitted to the NAS device 112 of site B 110.

In FIG. 1, the client 111 of site B 110 has already referred to file G′, and the file already subjected to data conversion (file G′) is stored in the namespace 142 for disclosing site B and a file system 113 of the NAS device 112 of site B. In this state, it is assumed that the data disclosure rule has been changed as (i), for example, in which the data conversion method is changed by the client 101 of site A 100. Then, the data conversion management device 130 performs the processes from (ii) to (iv).

In (ii), the data conversion management device 130 refers to the data disclosure management table 206 and a conversion tracking table 207, and specifies the file in which the conversion method had been changed out of the converted files.

In (iii), the data conversion management device 130 deletes the file data of the CAS device 140 having the data conversion method changed, and sets the corresponding file as a stub (file G′ to stub G). It is possible to use an invalidation means to set the file as an unreadable file, instead of deleting the file.

In (iv), the data conversion management device 130 deletes the file data (file G′) of site B 110 having the data conversion method changed, and sets the corresponding file as a stub (stub G′). In the example of FIG. 1, the file having the data conversion method changed is deleted and set as a stub, but it is also possible to store the file data having its data converted via the changed data conversion method.

As described, even when the data disclosure rule is changed, it becomes possible to facilitate data management via archive operation, and to ensure the privacy and security of critical file data (such as data having a high secrecy or data related to personal information) when the file data is disclosed to a different site.

### <Use Case: Medical System>

A use case of the present embodiment is the archive operation and contents sharing of medical data containing privacy information of patients. It is assumed that site A is “hospital A” and site B is “pharmaceutical company Q”, wherein “hospital A” (site A) archives the file data and discloses a portion of the data to the pharmaceutical company Q (site B). At this time, the archive destination of the file data of “hospital A” is set as the namespace for archive of site A, and the storage area that the “pharmaceutical company Q” can refer to is the namespace for access disclosure of site B (pharmaceutical company Q).

Further, the user of “hospital A” sets up a data disclosure rule (disclosure destination, disclosure condition, and data conversion method) of the file data to other sites, and the result of the setting is received by the NAS device. Further, the file data that the NAS device of “hospital A” periodically archives includes file data of patient information (personal information having a high secrecy, or critical data, such as patient's name, age, address, emergency contact number, health insurance information, name of disease, content of examination, and medical treatment information such as medication and operative treatment). In the patient information file data, the content matching the disclosure condition, for example, the file data of patient information including “drug X” or “drug Y” as the keyword of the medicine being prescribed, is disclosed. Other conditions, such as the name of disease or the age of the patient, can also be set as the disclosure condition.

A given data conversion method, such as k-anonymization (k=20) or cleansing method X, AES (Advanced Encryption Standard) method, DES (Data Encryption Standard) method and the like, is performed to the file data matching the disclosure condition to anonymize the file data, and then the data is disclosed to a site other than its own site “hospital A”. When the data disclosure rule is changed, the data converted file data stored in the NAS device of site B (pharmaceutical company Q) and the namespace for access disclosure of site B are deleted, or replaced with a new data converted file data having been subjected to the changed data conversion method.

As described, the data management via archive operation in a medical system can be facilitated, and the privacy and security of critical file data can be ensured upon disclosing the file data such as patient information to a different site.

### <Data Conversion Management Device>

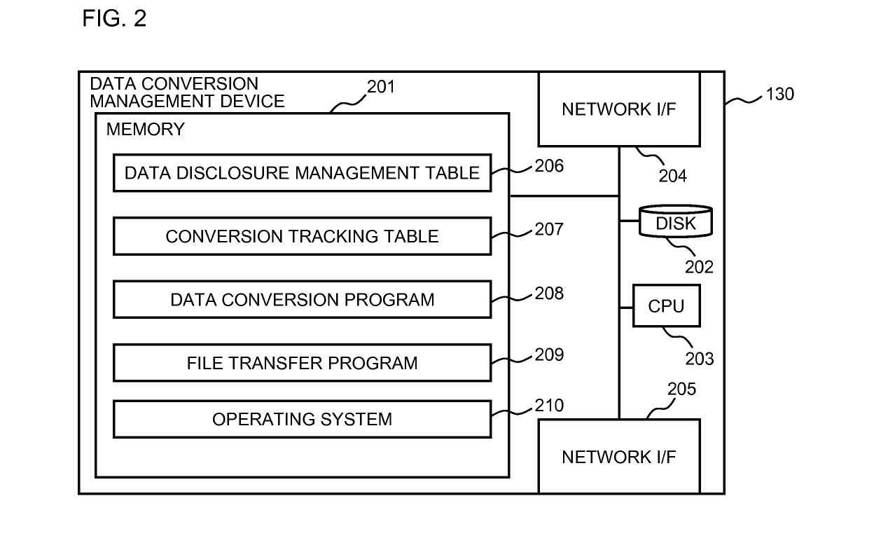

FIG. 2 is a block diagram illustrating a configuration example of hardware and software of a data conversion management device. The data conversion management device 130 includes a memory 201 storing programs and data, a disk 202 storing programs and data, a CPU 203 for executing programs stored in the memory 201 or the disk 202, a network interface 204 used for communication with the NAS device 102 of site A 100 and the NAS device 112 of site B 110 via the networks 150 and 160, and a network interface 205 used for communication with the CAS device 140 via the network 121, which are mutually connected via an internal communication path (such as a bus).

The memory 201 stores a data disclosure management table 206, a conversion tracking table 207, a data conversion program 208, a file transfer program 209, and an operating system 210. Further, the programs and tables stored in the memory can be stored in the disk 202 and read via the CPU 203 into the memory 201 for execution. The data disclosure management table 206 is a table for managing the data disclosure rule, and stores a file data provision source, a file data disclosure destination, a disclosure condition, and a data conversion method. The conversion tracking table 207 is a table for managing the file data subjected to the reference request from the NAS device at the data disclosure destination site, and converted in the data conversion management device 130.

The data conversion program 208 is a program having a function to convert the file data of the file data provision source to the file data of the file data provision destination based on a data conversion method of the data disclosure management table 206, a function to update the data disclosure management table 206, and a function to request creation of namespace for own site and namespace for disclosure. The file transfer program 209 is a program for transferring file data between the NAS devices 102/112 and the CAS device 140, requesting to delete file data of the respective devices, and requesting to store file data to the respective devices.

The operating system 210 is a program having an input/output control function and a read/write control function to the storage devices such as disks and memories, and for providing these functions to other programs. The data conversion management device 130 is illustrated as a single physical device, but it is possible to have the data conversion management device 130 and the CAS device 140 formed as a single physical device, and to have the respective tables and programs within the memory 201 illustrated in FIG. 2 stored within the memory of the CAS device 140.

### <NAS Device>

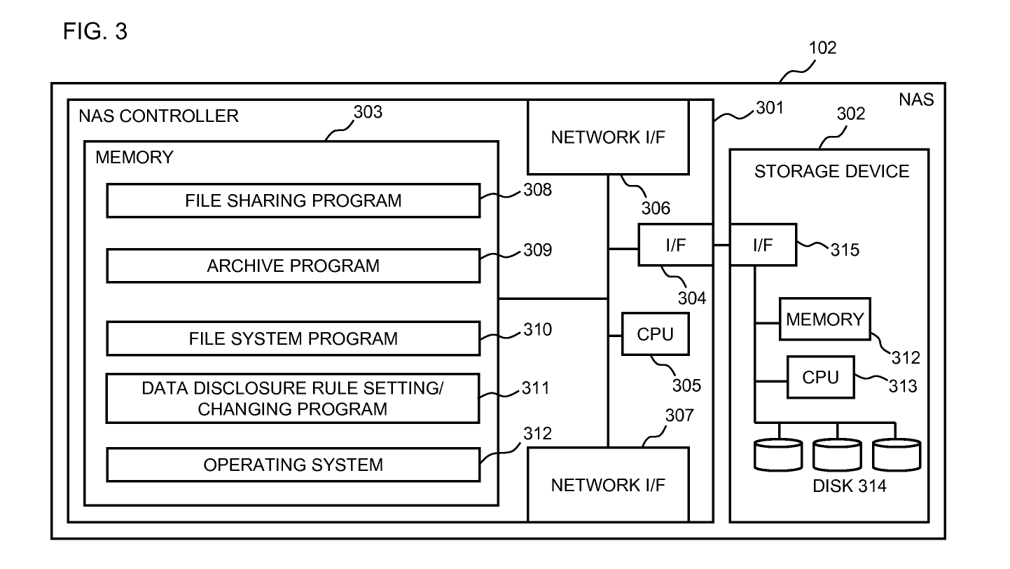

FIG. 3 is a block diagram illustrating a configuration example of a hardware and a software of the NAS device. The NAS device 102 has a NAS controller 301 and a storage device 302. The NAS device 112 of site B 110 has a similar configuration as the NAS device 102. The NAS controller 301 includes a CPU 305 executing the programs stored in a memory 303, a network interface 306 used for communicating with the client 101 via the network 104, a network interface 307 used for communicating with the data center system 120 via the network 150, a storage interface 304 used for the connection with the storage device 302, and a memory 303 for storing programs and data, which are mutually connected via a bus or the like.

The memory 303 stores a file sharing program 308, an archive program 309, a file system program 310, a data disclosure rule setting/changing program 311, and an operating system 312. The respective programs stored in the memory can be stored in the storage device 302, and read by the CPU 305 into the memory 303 for execution. The file sharing program 308 is a program for providing a means to allow the client 101 to perform file operation to the file data stored in the NAS device 102, and to allow the NAS device 102 to perform file operation to the file data stored in the CAS device 140, wherein the NAS device located in each site is enabled to execute a given file operation to the file data of its own site and the file data of other sites in the CAS device 140.

The archive program 309 is a program for migrating file data from the NAS device 102 to the CAS device 140 so as to save and store the same. The file system program 310 is a program for controlling a file system (not shown) within the NAS device 102. The operating system 312 is the same as the operating system 210. The data disclosure rule setting/changing program 311 is a program for setting the new registration contents of the data disclosure rule that the NAS device receives from the user to the data disclosure management table 206 or for updating the data disclosure management table 206 based on the changed contents.

The storage device 302 stores a storage interface 315 used for the connection with the NAS controller 301, a CPU 313 for executing the commands from the NAS controller 301, a memory 312 for storing programs and data, and one or more disks 314, which are mutually connected via a bus or the like. The storage device 302 provides to the NAS controller 301 a block-type storage function such as an FC-SAN (Fiber Channel Storage Area Network) and the like.

### <CAS Device>

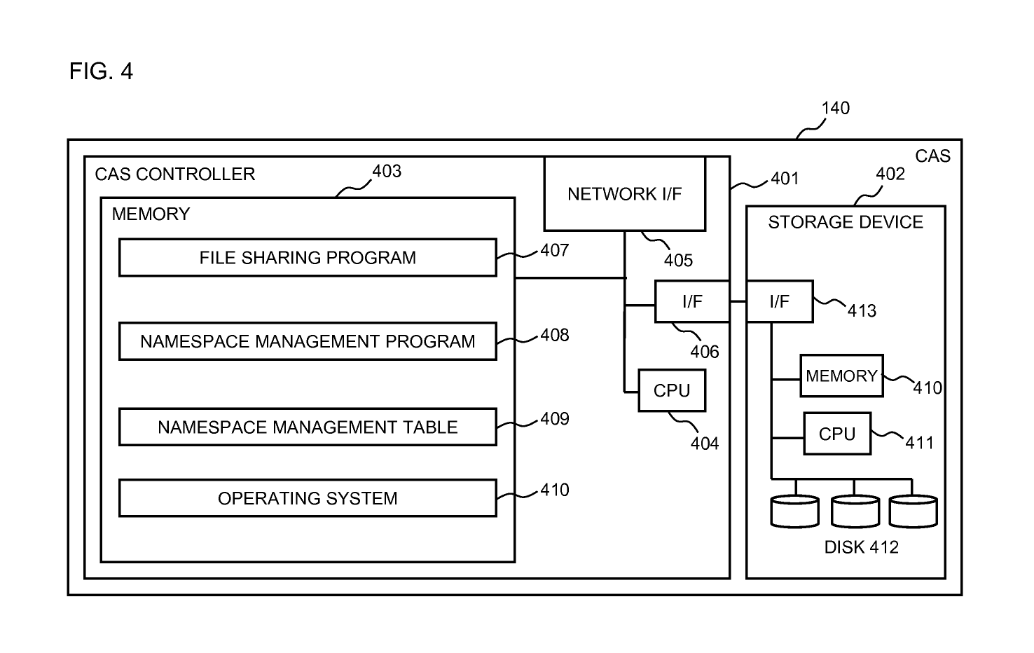

FIG. 4 is a block diagram illustrating a configuration example of hardware and software of the CAS device. The CAS device 140 includes a CAS controller 401 and a storage device 402. The CAS controller 401 comprises a CPU 404 for executing programs stored in a memory 403, a network interface 405 used for communicating with the data conversion management device 130 via the network 121, a storage interface 406 used for the connection with the storage device 402, and a memory 403 for storing programs and data, which are mutually connected via a bus and the like.

The memory 403 stores a file sharing program 407, a namespace managing program 408, a namespace management table 409, and an operating system 410. It is possible to have the respective programs and tables stored in the storage device 402, and read by the CPU 404 into the memory 403 for execution. The file sharing program 407 is a program for providing a means to enable the NAS devices 102 and 112 to operate the files in the CAS device 140. The file sharing program 407 enables to realize sharing of files between NAS devices. The operating system 410 is similar to the operating system 210.

The namespace managing program 408 is a program for controlling and managing the accesses from the NAS devices of the respective sites to the namespace of the CAS device 140. The namespace management table 409 is a table for managing which sites have access authority to the respective namespaces. The storage device 402 includes a storage interface 413 used for the connection with the CAS controller 401, a CPU 411 for executing commands from the CAS controller 401, a memory 410 for storing programs and data, and one or more disks 412, which are mutually connected via a bus or the like. The storage device 402 provides a block-type storage function such as an FC-SAN to the CAS controller 401.

### <Data Disclosure Management Table>

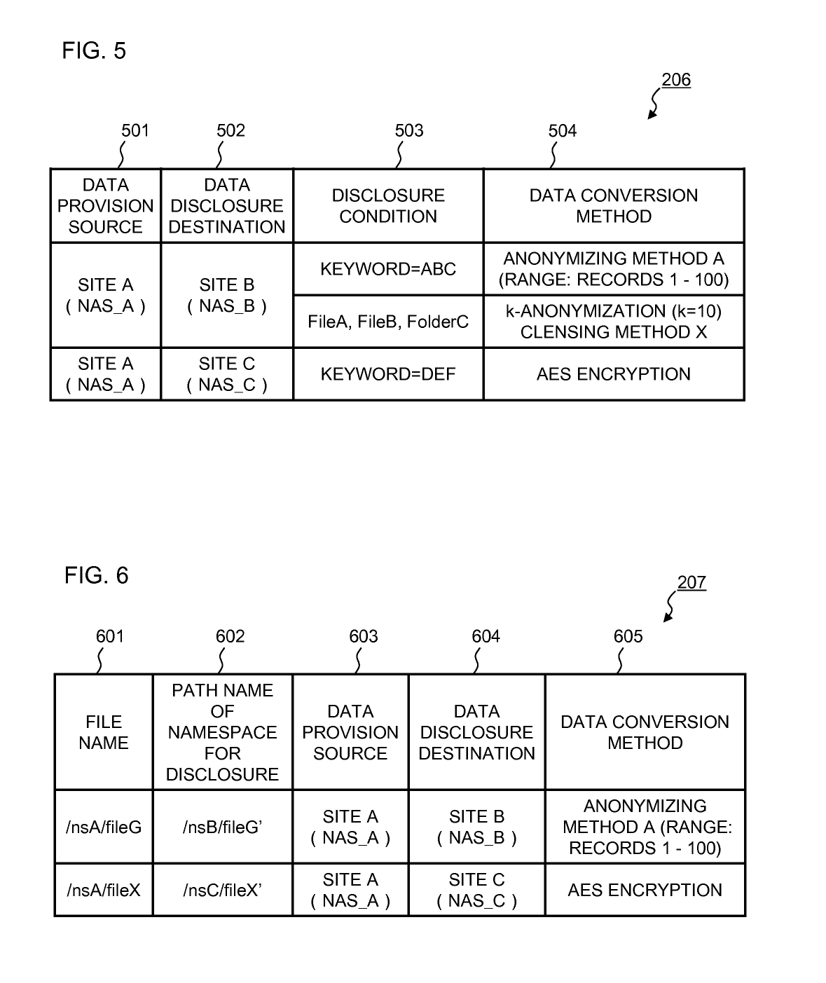

FIG. 5 is a view showing a configuration example of a data disclosure management table. The data disclosure management table 206 is a table for managing the data disclosure rule, which includes a file data provision source 501, a file data disclosure destination 502, a disclosure condition 503, and a data conversion method 504. Adding of entries to the data disclosure management table 206, updating of the setting contents, and deleting of entries are performed by the data conversion program 208 based on the requests from the NAS device, but the details thereof will be described later.

The file data provision source 501 stores a site name or a NAS device name providing the file data. The file data disclosure destination 502 stores the site name or the NAS device name to which the file data is provided. The disclosure condition 503 sets up conditions for providing file data from the file data provision source to the file data disclosure destination, wherein file names and folder names can be designated. Further, arbitrary keywords included in the file data or the metadata of files can be designated. For example, it is possible to designate a keyword=ABC as the disclosure condition, and to disclose the file including “ABC” in the file data.

The data conversion method 504 is a method for converting the original file data to a given file data via methods such as anonymizing, sanitizing, encryption and the like. It is possible to designate the conversion method to be applied not only to the whole file data but to a portion of the file data (in record units). For example, as shown in anonymizing method A (range: records 1 through 100), it is possible to designate record numbers 1 to 100 to be subjected to data conversion via anonymizing method A, and to not have the records of other areas subjected to data conversion. Further, when two or more data conversion methods are set up in the column of the data conversion method 504, it is possible to execute only the first data conversion or to execute all data conversion methods. If a plurality of entries exists in the same site and only one file data corresponds to the multiple disclosure conditions 502, it is possible to perform only the highest data conversion method or to perform all designated data conversion methods. For example, file A including the keyword “ABC” has three corresponding data conversion methods, which are anonymizing method A, k-anonymization (k=10), and cleansing method. It is possible to perform data conversion using one or two of the three methods, or to perform data conversion by using all three methods or a combination of two methods.

### <Conversion Tracking Table>

FIG. 6 is a view showing a configuration example of a conversion tracking table. A conversion tracking table 207 is a table for managing the file data subjected to reference request from a data disclosure destination site and converted via the data conversion management device 130. The conversion tracking table 207 includes a file name 601 for storing a storage location (namespace) and a name of the original file data to be disclosed, a path name 602 of the namespace for disclosure, a data provision source 603 illustrating a site (NAS device) providing the original file data, a data disclosure destination 604 illustrating a site (NAS device) to which the stub data or the data file having been converted is disclosed, and a data conversion method 605 for storing the varieties of the data conversion method.

The adding of entries, the updating of setting contents and the deleting of the entries of the conversion tracking table 207 are performed when the disclosure destination NAS device outputs a disclosure reference request of the file data having been subjected to data conversion or changes the data disclosure rule. The details of the process will be illustrated later. In the example of FIG. 6, the management information of file conversion is stored as a conversion tracking table 207, but it can also be stored as metadata to the file system of the CAS device 140. It is also possible to specify the data-converted file using a metadata search function (not shown) of the CAS device 140.

### <Data Disclosure Registration Processing>

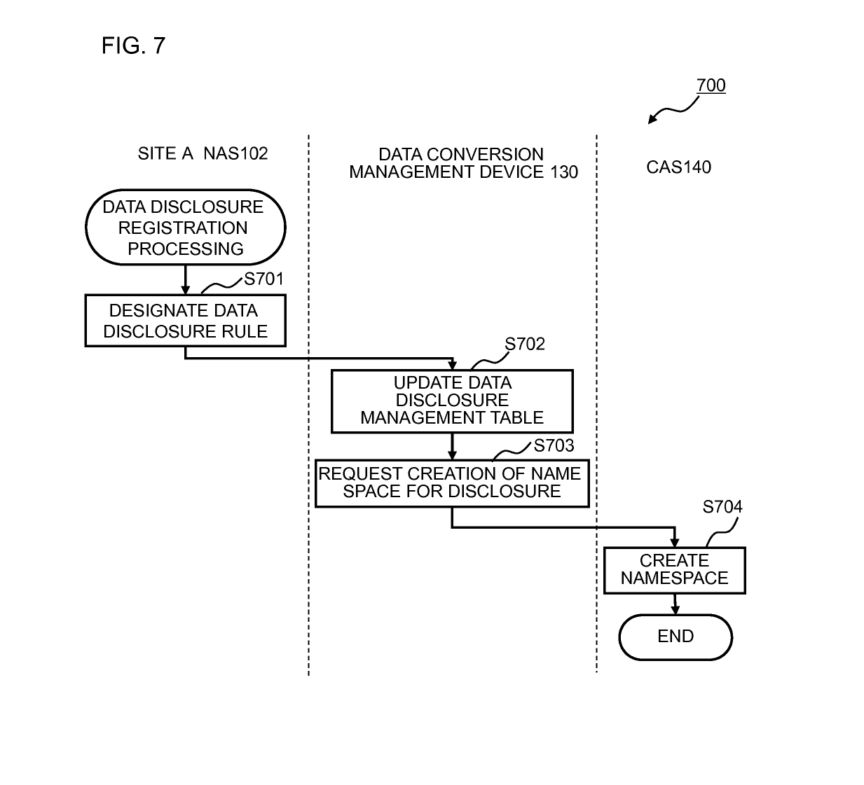

FIG. 7 is a flowchart illustrating a data disclosure registration processing. A data disclosure registration processing 700 is performed when the data conversion management device 130 receives a data disclosure rule designation request from the NAS device 102, so as to update the data disclosure management table 206 and to create a namespace for disclosure. What is meant by designating a data disclosure rule is to designate the data disclosure destination 502, the disclosure condition 503 and the data conversion method 504 of the data disclosure management table 206. The present process is started when the user of the client 101 enters a setting or an update request described later via a data disclosure rule setting/updating GUI interface.

In S701, the data disclosure rule setting/changing program 311 of the NAS device 102 receives a data disclosure rule designation from the user of the client 101, and sends the same to the data conversion management device 130. The data disclosure rule can not only be designated by the client 101, but can be designated by the administrator of the NAS device 102 or the system administrator of the information processing system 10, for example. In S702, the data conversion program 208 of the data conversion management device 130 updates the data disclosure management table 206 based on the contents of the received data disclosure rule. If there is no entry corresponding to the contents of the received data disclosure rule in the data disclosure management table 206, the data conversion program 208 adds an entry and stores the setting contents thereto.

In S703, the data conversion program 208 requests the CAS device 140 to create a data disclosure destination namespace (namespace 142 for disclosing site B). It is assumed that the namespace 141 for archive of site A in the CAS device 140 is created in advance via the namespace managing program 408. In S704, the namespace managing program 408 of the CAS device 140 creates the namespace 142 for disclosing site B and ends the data disclosure registration processing based on the request from the data conversion management device 130.

The present processing has been described assuming that the namespace 141 for archive of site A is already created in advance, but it is possible to have the namespace 141 for archive of site A created in S703, simultaneously as when the namespace 142 for disclosing site B is created. Further, it is possible to have the CAS device 140 receive the request from a system administrator of the information processing system 10, and to create a namespace in advance. In the present processing, the namespace 142 for disclosing site B is created in S703, but it is possible to have the administrator of the NAS device 102 or the system administrator of the information processing system 10 request the creation to the CAS device 140 at an arbitrary timing, and to create the namespace in advance.

### <Data Disclosure Processing>

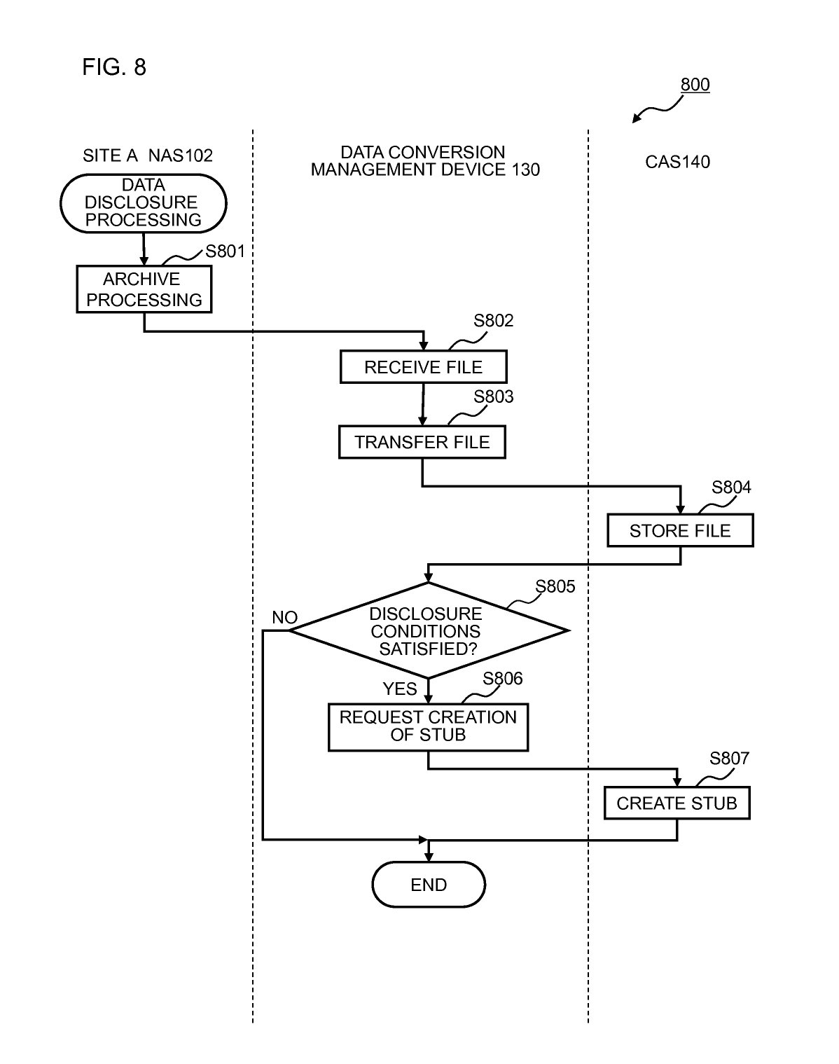

FIG. 8 is a flowchart illustrating a data disclosure processing. A data disclosure processing 800 is a processing for determining the file data of its own site to be disclosed to the NAS device of other sites.

In S801, the archive program 309 of the NAS device 102 executes an archive processing of migrating the file data in the NAS device 102 to the CAS device 140. This archive processing can be executed periodically (for example, once a day at late-evening hours when not many users are using the system) using a scheduler of the NAS device 102 or the like, or can be executed at a point of time when an order from the system administrator is received.

In S802, the file transfer program 209 of the data conversion management device 130 receives the file data to the CAS device 140. The data conversion management device 130 can store the received file data or the file data converted via the aforementioned data conversion method to the disk 202, in order to provide necessary file data speedily to the NAS device 112 of site B.

In S803, the file transfer program 209 transfers the received file data to the CAS device 140. In S804, the file sharing program 407 of the CAS device 140 stores the file data from the data conversion management device 130 to the namespace 141 for archive of site A. After completing storage, the file sharing program 407 transmits a completion notice to the data conversion management device 130.

In S805, the data conversion program 208 determines whether the received file data satisfies the disclosure condition or not based on the disclosure condition 503 stored in the data disclosure management table 206. If the data satisfies the disclosure condition (S805: Yes), the file transfer program 209 executes S806, and if not (No), the conversion program 208 ends the data disclosure processing 800. In S806, the file transfer program 209 requests the CAS device 140 to create a stub of the received file data.

In S807, the file sharing program 407 creates a stub in the namespace 142 for disclosing site B. That is, when “file F” is transmitted as file data from the NAS device 102, a stub “stub F” is stored in the namespace 142 for disclosing site B. The stub “stub F” is a management information indicating file data “file F”. After completing creation of the stub, the file sharing program 407 sends a completion notice to the data conversion management device 130, and ends the data disclosure processing 800.

In the data disclosure processing 800 of FIG. 8, a stub is created in the namespace for disclosure at the time of archive processing, but the timing for creating the stub is not restricted thereto. For example, the data conversion management device can search for a file archived from the NAS device 102 of site A to the CAS device 140 periodically and create a stub. Further, the archive can be directly archived to the CAS device 140 instead of via the data conversion management device 130.

Similarly, in the data disclosure processing 800, the stub is created in the CAS device 140, but it is possible to have the data conversion management device 130 perform data conversion in advance and to have the data-converted file data stored in the namespace for disclosure. For example, it is possible to store the file that will take up much time for the conversion processing as a data-converted file data, and to create a stub for the file that will not take up much time for conversion processing.

### <Data Reference Processing>

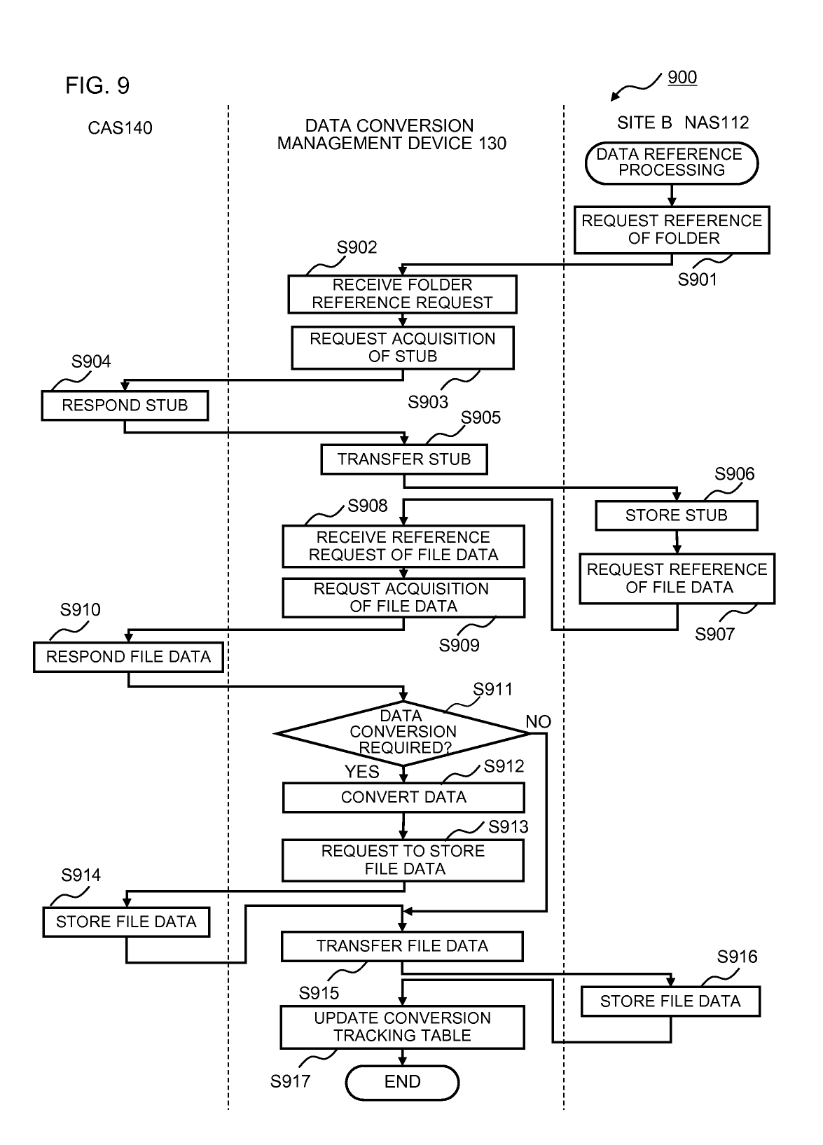

FIG. 9 is a flowchart illustrating a data reference processing. A data reference processing 900 is a processing performed for the NAS device 112 to refer to the file data in the namespace 142 for disclosing site B. The present processing is started based on a file data reference request from the NAS device 112.

In S901, when the NAS device 112 receives a folder reference request from the client 111, the file sharing program 308 transmits a reference request of the folder to the CAS device 140. In S902, the file transfer program 209 of the data conversion management device 130 receives a folder reference request to the CAS device 140. In S903, the file transfer program 209 transmits an acquisition request of a stub within the reference request folder to the CAS device 140. This is a case where the stub stored in the namespace 142 for disclosing site B designates a folder.

In S904, the file sharing program 407 of the CAS device 140 responds the corresponding stub to the data conversion management device 130. This stub is similar to the stub (created in S807) of the namespace 142 for disclosing site B designating the file data of the namespace 141 for archive of site A. In S905, the file transfer program 209 transfers a stub acquired from the CAS device 140 to the NAS device 112.

In S906, the file sharing program 308 stores the acquired stub in the file system 113. The actual storage location is the memory of the NAS controller or the memory or disk of the storage device. In S907, when the NAS device 112 receives a file reference request from the client 111, the file sharing program 308 transmits a reference request of file data to the CAS device 140.

In S908, the file transfer program 209 receives a file data reference request to the CAS device 140. In S909, the file transfer program 209 transmits a file data acquisition request to the CAS device 140. In S910, the file sharing program 407 sends the file data as response to the data conversion management device 130. If the file data of the acquisition request is a stub, the CAS device 140 acquires the corresponding file data from the namespace 141 for archive of site A, and responds to the data conversion management device 130. If the file data subjected to the acquisition request is a data-converted file, the data-converted file data stored in the namespace 142 for disclosing site B is sent as response to the data conversion management device 130.

In S911, the data conversion program 208 determines whether data conversion of the acquired file data is required or not based on the disclosure condition 503 of the data disclosure management table 206. If data conversion is necessary (S911: Yes), the data conversion program 208 executes S912, and if not (No), the program executes S915. The data-converted file can be cached in the memory 201 or the disk 202 of the data conversion management device 130, and the data-converted file can be responded to site B (NAS device 112) from the data conversion management device 130 without acquiring file data from the CAS device 140 when site B (NAS device 112) requests access to the file data. Since access to the CAS device 140 becomes unnecessary if the file is cached in the data conversion management device 130, the response time to the NAS device can be shortened.

Further, it is possible to have the data stored in the data conversion management device 130 without storing the same in the namespace for disclosure in the CAS device 140, and when an access request from site B (NAS device 112) is received, a response can be sent to site B (NAS device 112) without acquiring the file data from the CAS device 140. As described, high-speed access response can be realized by distributing the access processing from the NAS device among the data conversion management device 130 and the CAS device 140.

In S912, the data conversion program 208 performs data conversion of the file data acquired from the CAS device 140 via the data conversion method 504 in the data disclosure management table 206. In S913, the file transfer program 209 transmits a request to store the data-converted file data to the namespace 142 for disclosing site B to the CAS device 140. In S914, the file sharing program 407 stores the data-converted file data in the namespace 142 for disclosing site B. After the storage is completed, the file sharing program 407 transmits a completion notice to the data conversion management device 130.

In S915, the file transfer program 209 transfers the data-converted file data to the NAS device 112. In S916, the file sharing program 308 stores the data-converted file data in the file system 113. After completing storage, the file sharing program 308 transmits a completion notice to the data conversion management device 130. In S917, the data conversion program 208 updates the conversion tracking table 207, and ends the data reference processing. If a file data is to be disclosed newly, an entry is added to the conversion tracking table 207 and predetermined items such as the file name and the data disclosure destination are set.

According to the above process, in an environment where critical file data of its own site (site A) is archived for operation, it is possible to designate the conditions of data to be disclosed to a data reference destination (another site: site B) and the data conversion method thereof, and to enable only the file data matching the disclosure condition to be anonymized via a given data conversion method and provided to the data reference destination.

### <Data Disclosure Change Processing>

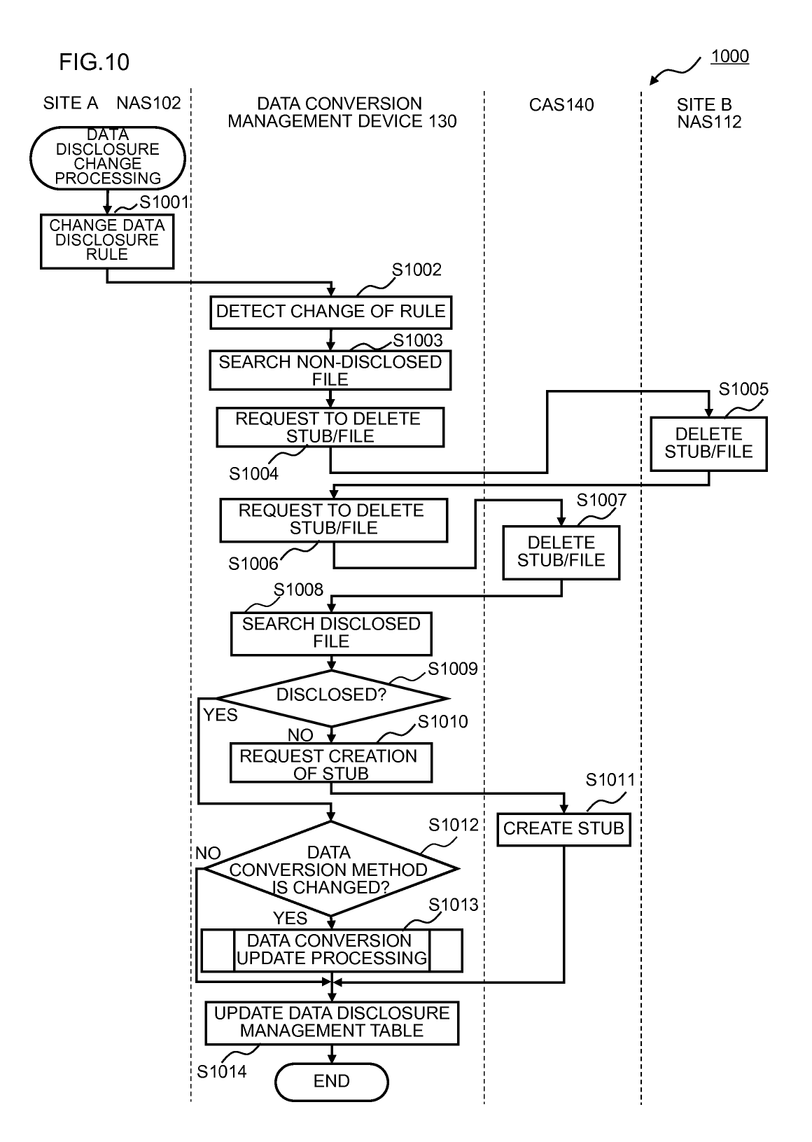

FIG. 10 is a flowchart illustrating a data disclosure change processing. A data disclosure change processing 1000 is a processing performed to delete the disclosed file data or to change the data conversion method, when the data disclosure rule has been changed.

In S1001, when the NAS device 102 receives a data disclosure rule change from the client 101, the data disclosure rule setting/changing program 311 transmits the data disclosure rule having been changed to the data conversion management device 130. In S1002, the data conversion program 208 of the data conversion management device 130 compares the acquired data disclosure rule with the data disclosure management table 206, and detects the change.

In S1003, the data conversion program 208 searches the file that should be set as non-disclosed. This process specifies a file that can be disclosed according to the data disclosure rule before it is changed, but cannot be changed according to the changed data disclosure rule. For example, if the keyword is set as “ABC” in the disclosure condition 503 and the file data containing the keyword “ABC” is disclosed, wherein when the disclosure keyword is changed from “ABC” to “XYZ”, it is necessary to set the relevant file data as non-disclosed. Therefore, all the file data containing the keyword “ABC” are specified according to the present processing.

In S1004, the file transfer program 209 requests the NAS device 112 to delete the delete target file data and the stub. In S1005, the file sharing program 308 of the NAS device 112 deletes the corresponding file data and the stub in the file system 113. After completing the delete processing, the file sharing program 308 transmits a delete completion notice to the data conversion management device 130.

In S1006, the file transfer program 209 requests the CAS device 140 to delete the delete target file data and the stub. Then, the data conversion program 208 deletes the corresponding entry of the conversion tracking table 207. In S1007, the file sharing program 407 of the CAS device 140 deletes the corresponding file and stub in the namespace 142 for disclosing site B. After completing the delete processing, the file sharing program 407 transmits a delete complete notice to the data conversion management device 130. The order of the request for deleting a file of S1005 and S1007 is not restricted to the above example, and the request can be provided to the CAS device 140 and the NAS device 112 in parallel.

In S1008, the data conversion program 208 executes a search of the disclosed files. This process is performed to search a file that can be disclosed both before and after changing the data disclosure rule and a file that has not been disclosed before changing the rule but can be disclosed after changing the rule. In S1009, the data conversion program 208 determines whether the file data specified via the process of S1008 is already disclosed or not. If it is disclosed (S1009: Yes), the data conversion program 208 causes the file transfer program 209 to execute S1012, and if it is not disclosed (No), the program executes S1010.

In S1010, the file transfer program 209 transmits a stub creation request to the CAS device 140. In S1011, the file sharing program 407 creates a stub in the namespace 142 for disclosing site B. After completing creation of a stub, the file sharing program 407 transmits a creation complete notice to the data conversion management device 130. In S1012, the data conversion program 208 determines whether the data conversion method has been changed or not based on the data disclosure rule. The data conversion program 208 executes S1013 when the method has been changed (S1012: Yes), and executes S1014 when the method has not been changed (No).

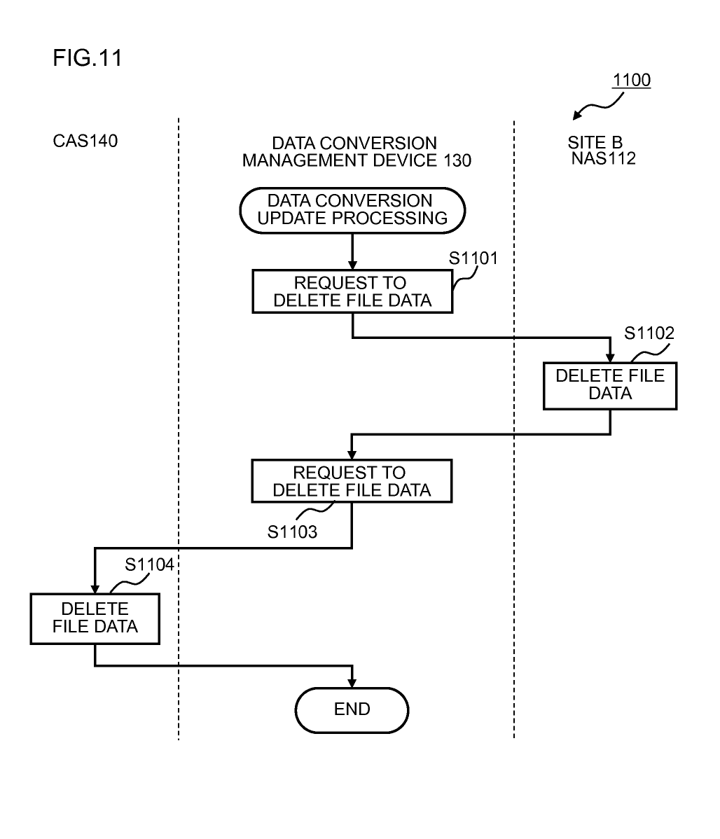

In S1013, the data conversion program 208 executes a data conversion update processing. The data conversion update processing can adopt multiple methods according to the use case, and four processing examples will be described in detail with reference to FIGS. 11 through 14. In S1014, the data conversion program 208 executes update of the data disclosure management table 206 based on the contents of the changed data disclosure rule, and ends the data disclosure change processing.

According to the above-described processing, when the data disclosure rule has been changed, the file data and stub that must be set as non-disclosed are deleted, so that the privacy and security of critical data can be maintained.

### <First Data Conversion Update Processing>

FIG. 11 is a flowchart illustrating an example of a first data conversion update processing. A first data conversion update processing 1100 is a process for deleting the corresponding file data when the data conversion method is updated.

In S1101, the file transfer program 209 of the data conversion management device 130 transmits a file data delete request to the NAS 112. In S1102, the file sharing program 308 of the NAS device 112 deletes the file data subjected to the request from the file system 113. After deleting the file, the file sharing program 308 transmits a delete completion notice to the data conversion management device 130.

In S1103, the file transfer program 209 transmits a file data delete request to the CAS device 140. Thereafter, the data conversion program 208 deletes the corresponding entry of the conversion tracking table 207. The order of the file delete request of S1101 and S 1103 is not restricted thereto, and a delete request can simultaneously be output to the CAS device 140 and the NAS device 112.

In S1104, the file sharing program 407 of the CAS device 140 deletes the file data corresponding to the delete request from the namespace 142 for disclosing site B, and creates a stub. After deleting the file data, the file sharing program 407 transmits a delete completion notice to the data conversion management device 130, and ends the data conversion update processing. In the illustrated example, the data conversion update processing 1100 deletes the file having its data conversion method changed and creates a stub, but it is also possible to store a file data having been data-converted via the data conversion method after the change. For example, it is possible to have a data conversion time threshold set up in advance, wherein the files having a data conversion time longer than the threshold has a file data subjected to data conversion via the changed data conversion method stored, while the files having a data conversion time shorter than the threshold remain as a stub.

According to the data disclosure rule change processing and the data conversion update processing described with reference to FIGS. 10 and 11, it becomes possible to specify and delete the file data to be non-disclosed based on the changed data disclosure rule, and even when the data conversion method has been changed, the privacy and security of critical file data can be maintained by deleting the converted file data provided to site B.

### <Second Data Conversion Update Processing>

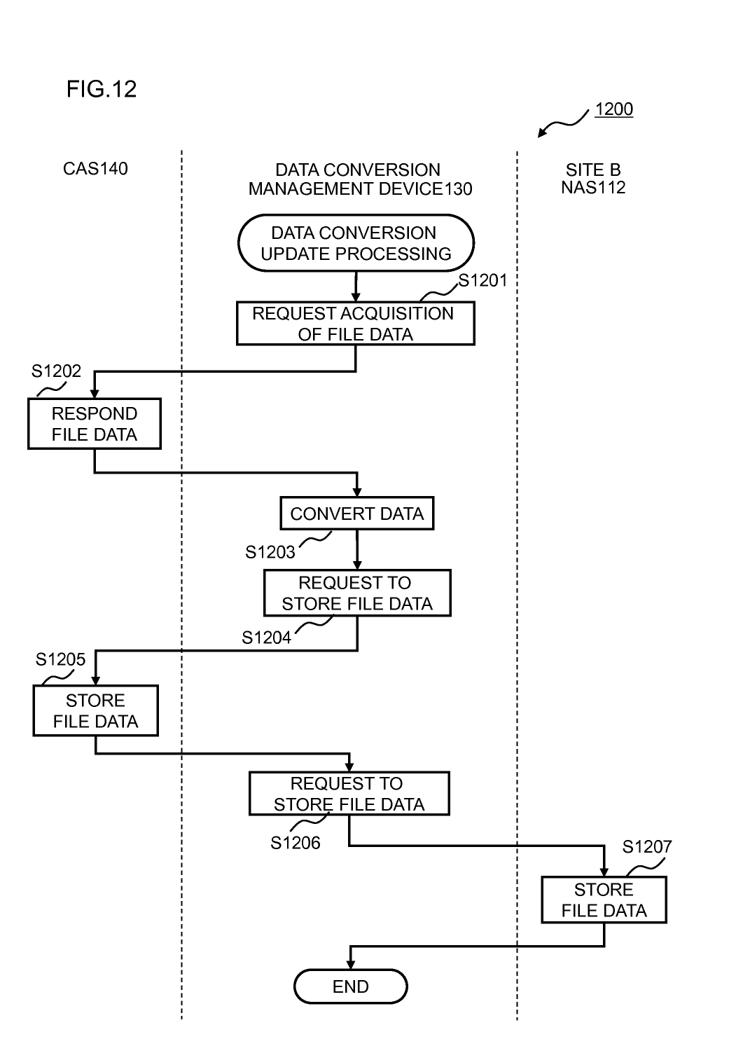

FIG. 12 is a flowchart illustrating an example of a second data conversion update processing. A second data conversion update processing 1200 is a process for converting the file data based on the changed data conversion method, and replacing the file data before change with the data-converted file data.

In S1201, the file transfer program 209 of the data conversion management device 130 transmits a file data acquisition request to the CAS device 140. In S1202, the file sharing program 407 of the CAS device 140 acquires the file data corresponding to the acquisition request from the namespace 141 for archive of site A, and responds to the data conversion management device 130. In S1203, the data conversion program 208 subjects the file data acquired from the CAS device 140 to data conversion via the data conversion method having been changed according to the data conversion method 504 in the data disclosure management table 206.

In S1204, the file transfer program 209 transmits a storage request of data-converted file data to the CAS device 140. In S1205, the file sharing program 407 stores the received file data subjected to data conversion to the namespace 142 for disclosing site B. After storing the file data, the file sharing program 407 transmits a completion notice to the data conversion management device 130.

In S1206, the file transfer program 209 transmits a storage request of the data-converted file data to the NAS device 112. Then, the data conversion program 208 adds an entry to the conversion tracking table 207, and sets the contents related to the data-converted file data. In S1207, the file sharing program 308 of the NAS device 112 stores the received data-converted file data to the file system 113. After storage is completed, the file sharing program 308 transmits a storage completion notice to the data conversion management device 130, and ends the second data conversion update processing.

As described, the privacy and security of critical data can be maintained by replacing the disclosed file data with the data-converted file data via the new data disclosure rule.

### <Third Data Conversion Update Processing>

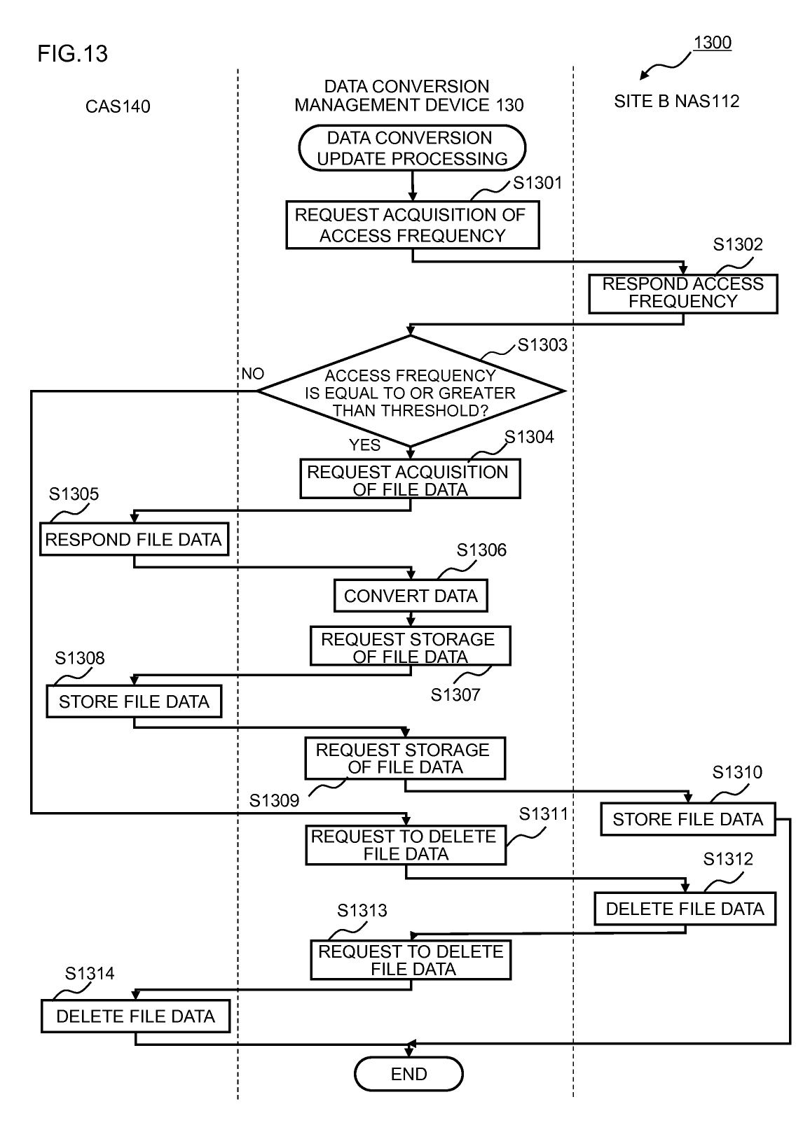

FIG. 13 is a flowchart illustrating an example of a third data conversion update processing. A third data conversion update processing 1300 is a process of replacing a file having a high access frequency out of the file data having their data conversion method changed with the file data via the changed data conversion method, and deleting the file data of a file having a low access frequency and creating a stub.

In S1301, the file transfer program 209 of the data conversion management device 130 transmits to the file system 113 of the NAS device 112 a request to acquire the access frequency of a data-converted file data having its data conversion method changed. In S1302, the file sharing program 308 of the NAS device 112 sends a response to the data conversion management device 130 regarding the access frequency of the target file.

In S1303, the data conversion program 208 determines whether the acquired access frequency is equal to or greater than an access frequency stored in advance in the data conversion management device 130. The data conversion program 208 executes S1304 if the frequency is equal to or greater than the access frequency threshold (S1303: Yes), and executes S1311 if the frequency is smaller than the access frequency threshold (No). In S1304, the file transfer program 209 transmits a request to acquire file data of the namespace 141 for archive of site A to the CAS device 140. At this time, the file data is the original file data (file G) of the data-converted file data (file G′) having the data conversion method changed.

In S1305, the file sharing program 407 of the CAS device 140 responds the corresponding file data to the data conversion management device 130. In S1306, the data conversion program 208 performs data conversion via the changed data conversion method 504 of the acquired file data. The result is referred to as file G″. In S1307, the file transfer program 209 transmits a request to store the file data subjected to data conversion (file G″) to the CAS device 140.

In S1308, the file sharing program 407 stores the acquired file data subjected to data conversion (file G″) to the namespace 142 for disclosing site B. After completing storage, the file sharing program 407 transmits a storage completion notice to the data conversion management device 130. In S1309, the file transfer program 209 transmits a storage request of the data-converted file data to the NAS device 112.

In S1310, the file sharing program 308 stores the data-converted file data to the file system 113. After completing storage, the file sharing program 308 transmits a completion notice to the data conversion management device 130, and ends the third data conversion update processing 1300. In S1311, the file transfer program 209 transmits a request to delete the data-converted file data via the previous disclosure rule to the NAS device 112.

In S1312, the file sharing program 308 deletes the corresponding file data of the file system 113 and creates a stub (stub G′). After completing the deleting process, the file sharing program 308 transmits a delete completion notice to the data conversion management device 130. In S1313, the file transfer program 209 transmits a request to delete the data-converted file data via the previous data disclosure rule to the CAS device 140.

In S1314, the file sharing program 407 deletes the corresponding data-converted file data in the namespace 142 for disclosing site B, and creates a stub (Stub G). After completing the deleting process, the file sharing program 407 transmits a delete completion notice to the data conversion management device 130, and ends the third data conversion update processing 1300. Although not shown, the conversion tracking table 207 is updated after transmitting the request to store the data-converted file data of S1309 or the request to store the data-converted file data of S1313. The update of the conversion tracking table 207 can also be performed at a timing of reception of the storage completion notice of the NAS device 112 in the data conversion management device 130 or reception of delete completion notice of the CAS device 140.

As described, the file having a high access frequency is highly possible to be accessed immediately, so that by storing in advance the file data having been subjected to data conversion by the changed data conversion method, the access response time of the file data can be shortened. It is also possible to combine the data conversion time and the access frequency to determine the file data to be subjected to data conversion. For example, the file data having a low access frequency and a short data conversion time can be set as a stub, and the other file data can be subjected to data conversion. Since data conversion is completed in advance for the file data having a high access frequency or a long data conversion time, the response to the NAS device can be increased in speed.

### <Fourth Data Conversion Update Processing>

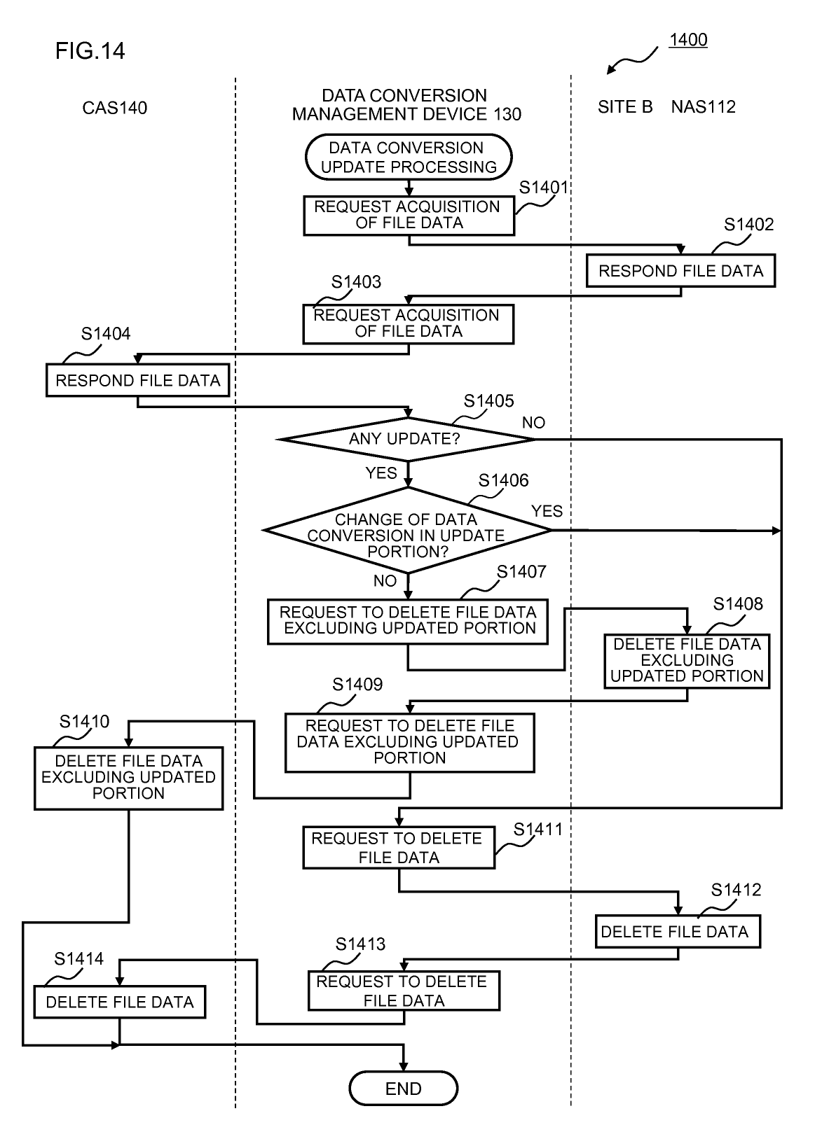

FIG. 14 is a flowchart illustrating an example of a fourth data conversion update processing. A fourth data conversion update processing 1400 is a process for not deleting the file data if the update location is not influenced by the changing of the data conversion method, and deleting the file data for other cases, when the file data is updated in the NAS device 112 of site B.

In S1401, the file transfer program 209 of the data conversion management device 130 transmits a request to acquire the file data subjected to data conversion to the NAS device 112 of site B. In S1402, the file sharing program 308 of the NAS device 112 responds the data-converted file data stored in the file system 113 to the data conversion management device 130. In S1403, the file transfer program 209 transmits a request to acquire the data-converted file data to the CAS device 140.

In S1404, the file sharing program 407 of the CAS device 140 responds the data-converted file data stored in the namespace 142 for disclosing site B to the data conversion management device 130. In S1405, the data conversion program 208 determines whether the file data subjected to data conversion acquired from the NAS device 112 is updated or not by comparing the same with the file data subjected to data conversion acquired from the namespace 142 for disclosing site B. If the data is updated (S1405: Yes), the data conversion program 208 executes S1406. If it is not updated (S1405: No), the file transfer program 209 executes S1411.

In S1406, the data conversion program 208 determines whether there is a change in the data conversion method in the updated area of the data-converted file data. For example, it is assumed that there is a file data subjected to data conversion having 200 records, wherein the former 100 records are subjected to data conversion via anonymizing method A, while the latter records starting from the 101st record have been updated in the NAS device 112. If the data conversion method of the former 100 records is not changed, the file data subjected to data conversion as a whole is effective so that it will not be deleted. However, if the data conversion method of the former 100 records is changed, the file data excluding the updated portion is deleted. In the present processing, the file data excluding the updated portion is deleted, but it is possible to delete the file data including the updated portion.

In S1407, the file transfer program 209 transmits a delete request of the data-converted file data other than the updated portion to the NAS device 112. In S1408, the file sharing program 308 deletes the data-converted file data excluding the updated portion in the file system 113, and a stub is created. After deleting is completed, the file sharing program 308 transmits a delete completion notice to the data conversion management device 130. In S1409, the data conversion program 208 transmits a delete request of the data-converted file data excluding the updated portion to the CAS device 140.

In S1410, the file sharing program 407 deletes the data-converted file data excluding the updated portion in the namespace 142 for disclosing site B and creates a stub. After deleting is completed, the file sharing program 407 transmits a delete completion notice to the data conversion management device 130. The processes of S1411 to S1414 are the same as the processes of S1311 to S1314 of FIG. 13, so that the detailed description thereof will be omitted.

As described, if the data-converted file data is updated in the NAS device 112 of site B, when the updated area is not influenced by the change of data conversion method, the data-converted file data will not be deleted. Therefore, the client 111 can continue to use the data-converted file data without losing the content that he/she has updated. The subjects of the processes from FIG. 7 to FIG. 14 are the respective programs, but they can also be hardware resources such as devices or the CPU of devices.

### <Data Disclosure Rule Setting/Updating GUI Interface>

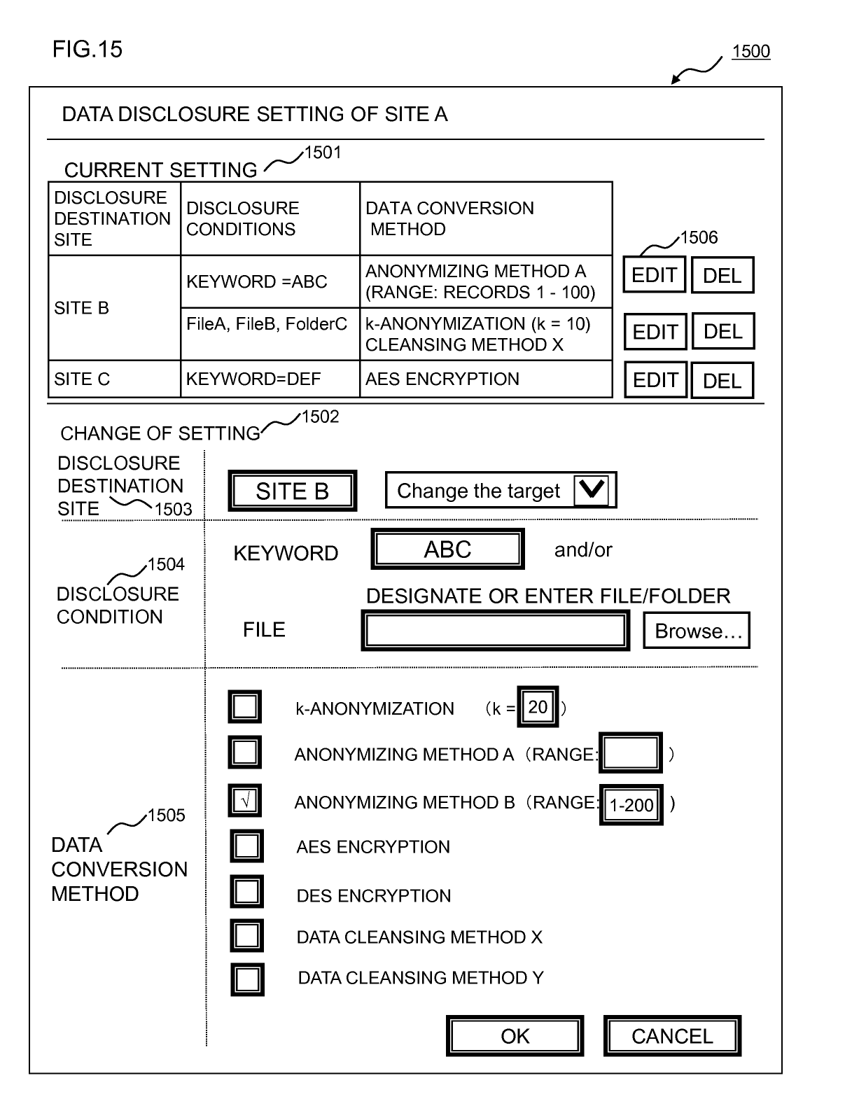

FIG. 15 is a view illustrating a configuration example of a data disclosure rule setting/updating GUI (Graphical User Interface). A data disclosure rule setting/updating GUI interface 1500 is controlled via the data disclosure rule setting/changing program 311, and composed of a display area 1501 for displaying the contents of the current setting, and an input area 1502 for receiving input of the change of settings (hereinafter referred to as input area 1502). The input area 1502 is further composed of a disclosure destination site setting area 1503, a disclosure condition setting area 1504, and a data conversion method setting area 1505.

The current setting content display area 1501 displays the contents stored in the data disclosure management table 206. The disclosure destination site setting area 1503 is for setting up the site name to which the file data is to be disclosed. The disclosure condition setting area 1504 is for setting the keyword contained in the disclosed file data, or the file name or the folder name thereof. The keywords, the file name or the folder name can be set individually or in combination.

The data conversion method setting area 1505 is composed of a plurality of anonymizing methods, sanitizing methods and encryption methods, and can perform data conversion by one method or a combination of two or more methods. In the present embodiment, methods such as k-anonymization method, simple anonymizing method, data cleansing method, AES encryption method, and DES encryption method can be used. The input area 1502 is displayed when an EDIT button 1506 of the display area 1501 of the current setting is pressed, and the setting is enabled. Then, the data disclosure management table 206 is updated by the contents entered via the input area 1502. Further, although not shown, it is possible to set the threshold of the access frequency as mentioned earlier or the threshold of the data conversion time. Such user interface enables to improve the user-friendliness of the system.

As described, it becomes possible to ensure privacy and security of critical data when disclosing the data to another site while providing a means for facilitating data management via archive operation. The files having a high access possibility should be stored as a file subjected to data conversion by executing data conversion in advance instead of a stub, to thereby shorten the access response time.

The present invention is not restricted to the above-illustrated preferred embodiments, and can include various modifications. The present invention is not restricted to include all the components illustrated above. Further, a portion of the configuration of an embodiment can be replaced with the configuration of another embodiment, or the configuration of a certain embodiment can be added to the configuration of another embodiment.

Moreover, a portion of the configuration of each embodiment can be added to, deleted from or replaced with other configurations. A portion or whole of the above-illustrated configurations, functions, processing units, processing means and so on can be realized via hardware configuration such as by designing an integrated circuit. Further, the configurations and functions illustrated above can be realized via software by the processor interpreting and executing programs realizing the respective functions.

The information such as the programs, tables and files for realizing the respective functions can be stored in a storage device such as a memory, a hard disk or an SSD (Solid State Drive), or in a memory media such as an IC card, an SD card or a DVD. Only the control lines and information lines considered necessary for description are illustrated in the drawings, and not necessarily all the control lines and information lines required for production are illustrated. In actual application, it can be considered that almost all the components are mutually connected.

### REFERENCE SIGNS LIST

10 Computer system
100, 110 Sub-computer system
101, 111 Client
102, 112 NAS device
130 Data conversion management device
140 CAS device
141 Namespace for archive of site A
142 Namespace disclosure of site B
201, 303, 403 Memory
203, 305, 404 CPU
206 Data disclosure management table
207 Conversion tracking table
208 Data conversion program
209 File transfer program
301 NAS controller
302 Storage device
308 File sharing program
309 Archive program
311 Data disclosure rule setting/changing program
401 CAS controller
402 Storage device
407 File sharing program
408 Namespace management program
409 Namespace management table
1501 Data disclosure rule setting/updating GUI interface

1. An information processing system comprising a plurality of sub-computer systems including a first sub-computer system and a second sub-computer system for providing a stored file data to a client computer, and a data management computer system connected to the plurality of sub-computer systems;
the data management computer system comprising:
a storage system;
wherein the data management computer system stores a file data migrated from the plurality of sub-computer systems in the storage system;
stores a file data disclosure rule to the second sub-computer system regarding a migration file data from the first sub-computer system;
the file data disclosure rule including a data disclosure condition and a data conversion method of the file data;
determines whether reference is possible or not based on the data disclosure condition when a reference request is received from the second sub-computer system to a migration file data from the first sub-computer system;
provides the file data having been converted via the data conversion method to the second sub-computer system when reference is enabled; and
deletes the file data provided to the second sub-computer when the file data disclosure rule has been changed.

2. The information processing system according to claim 1, wherein
the storage system comprises a first storage area for storing a file data of the first sub-computer system, and a second storage area in which the second sub-computer system refers to the file data; and
when the file data stored in the first storage area satisfies the data disclosure condition,
the data management computer system creates a first management data indicating a file data of the first storage area and stores the same in the second storage area.

3. The information processing system according to claim 2, wherein
the data management computer system
receives a reference request of the second storage area from the second sub-computer system, and
creates a second management data indicating the first management data, and provides the same to the second sub-computer system.

4. The information processing system according to claim 3, wherein
the data management computer system
receives a reference request of the second management data from the second sub-computer system; and
stores the file data converted via the data conversion method in the second storage area, and provides the same to the second sub-computer system.

5. The information processing system according to claim 4, wherein
when the file data disclosure rule is changed, the data management computer system
specifies, out of the file data stored in the second storage area, a file data not satisfying a data disclosure condition of the changed file data disclosure rule or a file data not converted via the changed data conversion method, and deletes the corresponding file data from the second storage area and the second sub-computer system.

6. The information processing system according to claim 5, wherein
the data management computer system
replaces a file data that has become a delete target by the data conversion method being changed with a file data converted via a data conversion method according to a changed file data disclosure rule.

7. The information processing system according to claim 5, wherein
the data management computer system
acquires from the second sub-computer system an access frequency of the file data that has become a delete target by the data conversion method being changed, and compares the access frequency with an access frequency threshold value stored in advance;
when the access frequency is equal to or greater than the access frequency threshold, replaces the data by the file data having been converted via the changed data conversion method; and
when the access frequency is smaller than the access frequency threshold, deletes the delete target file data.

8. The information processing system according to claim 5, wherein
the data management computer system
computes a data conversion time via the changed data conversion method with respect to a file data that has become a delete target by the data conversion method being changed;
compares the computed data conversion time with a data conversion time threshold stored in advance;
when the computed data conversion time is equal to or greater than the data conversion time threshold, replaces the file data with a file data converted by the changed data conversion method; and
when the computed data conversion time is smaller than the data conversion time threshold, deletes the delete target file data.

9. The information processing system according to claim 5, wherein
when a file data provided from the data management computer system is updated and data conversion is not necessary for the update portion after the file data disclosure rule is changed, the second sub-computer system
deletes data excluding the updated portion of the file data.

10. The information processing system according to claim 1, wherein the plurality of sub-computer systems comprises:
a management interface; and
receives an entry of setting of the file data disclosure rule via the management interface, and displays the set file data disclosure rule.

11. The information processing system according to claim 1, wherein the data conversion method is any one or more of the following methods: a k-anonymization method, a simple anonymizing method, a data cleansing method, an AES encryption method, and a DES encryption method.

12. The information processing system according to claim 11, wherein two or more of the data conversion methods are combined to perform data conversion of file data.

13. A method for processing data in an information processing system comprising a plurality of sub-computer systems including a first sub-computer system and a second sub-computer system for providing a stored file data to a client computer, and a data management computer system connected to the plurality of sub-computer systems;
the data management computer system comprises a storage system;
wherein the data management computer system:
stores a file data migrated from the plurality of sub-computer systems in the storage system;
stores a file data disclosure rule to the second sub-computer system regarding a migration file data from the first sub-computer system;
the file data disclosure rule including a data disclosure condition and a data conversion method of the file data;
determines whether reference is possible or not based on the data disclosure condition when a reference request is received from the second sub-computer system to a migration file data from the first sub-computer system;
provides the file data having been converted via the data conversion method to the second sub-computer system when reference is enabled; and
deletes the file data provided to the second sub-computer when the file data disclosure rule has been changed.
